(19) United States
(12) Patent Application Publication
(10) Pub. No.: US 2005/0150158 A1
(43) Pub. Date: Jul. 14, 2005

(54) Fiberglass lawn edging with integral electrical conductor

(76) Inventor: M. John Fakhari, Keller, TX (US)

Correspondence Address: Entrepreneurial Studies and Development, CMSU Dockery Suite 102, Warrensburg, MO, 64093, US

(21) Appl. No.: 11/076,372

(22) Filed: Mar. 9, 2005

Related U.S. Application Data
(63) Continuation-in-part of application No. 10/234,991, filed on Sep. 4, 2002.

(51) Int. Cl. A01G 1/08

(52) U.S. Cl. 47/33

(57) ABSTRACT

A pultruded fiberglass lawn edging includes imbedded conductors which can be used to conduct low voltage electricity to allow the lawn edging to double as a lighting strip. If the conductors are wires positioned adjacent the top and bottom edges of the edging, they also act as structural reinforcements which strengthen the edges to prevent damage which would otherwise be caused when the edging is driven onto the ground. The wires can also be used to flexibly interconnect adjacent sections of edging.

This application is a continuation in part of co-pending application Ser. No. 10/234,991 filed Sep. 4, 2002.

### BACKGROUND OF THE INVENTION

1. Field of the Invention

The present invention relates to material provided for lawn and garden edging. The present invention also relates to low voltage outdoor lighting.

2. Description of the Related Art

Lawn edging is typically used to provide a sharp line between two areas of diverse plant growth in a lawn. In the past a variety of edging systems have been developed.

U.S. Pat. No. 1,977,021 discloses a sheet metal edging. While sheet metal is flexible and inexpensive it tends to corrode quickly, particularly in this application where lawn and garden fertilizers are often being used.

U.S. Pat. No. 5,941,018 discloses a lawn edging system including stakes used to hold the edging in place. This patent discloses many of the common materials used for edging including molded or extruded plastic and aluminum extrudate. Each of these materials has problems. Most plastics hold up well in ground contact, but do not hold up well when exposed to UV light from the sun and to freezing conditions. Lawn edging must also be tough because lawn and garden equipment such as lawn mowers and bladed lawn edgers are often used right up next to the edging material. Most plastics are not tough enough to last more then a few seasons in this kind of abusive environment. While aluminum is tougher then plastic, it must be coated to look good and resist the corrosion of fertilizers. The coating system usually fails after just a few seasons.

It is therefore desirable to have a lawn edging system that is attractive, tough, corrosion and UV resistant, inexpensive to manufacture, and easy to install.

### SUMMARY OF THE INVENTION

The invention consists of pultruded fiberglass edging. The resulting edging material is flexible yet tough and resistant to a variety of environmental factors.

Unlike steel and even aluminum, pultruded fiberglass is lightweight and easy to machine using just hand tools. Fiberglass also resists corrosion even in soil with fertilizer. Fiberglass is tougher then plastic and is also resistant to UV degradation. The present invention envisions a boarder installation method where the edging material and stakes are bundled together. These bundles would be the most efficient way to ship the raw materials to build the system. Once on the job site the bundles would be opened up and the system could be installed.

Once a length of edging has been pultruded it can be rolled up and packaged as a roll. During installation the material is flexible enough to be bent around obstacles. Connectors are available to join lengths of material and to make corners. Stakes can be of metal, plastic or of pultruded fiberglass material.

It is also foreseen that copper wires or other electrical conductors could be formed in the edging, to serve as conductors for low voltage electrical lights or related applications.

### BRIEF DESCRIPTION OF THE DRAWINGS

FIG. 1 is a perspective view an edging system according to the present invention installed.

FIG. 2 is an elevation view of a stake which forms a part of the edging system.

FIG. 3 is a plan view of a coil of edging material which forms a part of the edging system.

FIG. 4 is a perspective view of a corner connector which forms a part of the edging system.

FIG. 5 is a perspective view of a straight connector which forms a part of the edging system.

FIG. 6 is an exploded view showing the layers of the edging.

FIG. 7 is a perspective view showing the process for manufacturing the edging.

FIGS. 8a and 8b are perspective views of a second embodiment of the fiberglass edging having electrical conductors embedded therein.

FIGS. 9a and 9b are perspective views showing a first method of connecting the conductors of the second embodiment of FIGS. 8a and 8b.

FIG. 10 is a perspective view showing the second embodiment of FIG. 8 being installed.

FIG. 11 is a perspective view showing a first clip which can be used to join sections of edging made according to the second embodiment.

FIG. 12 is a perspective view showing a second clip which can be used to joint sections of edging made according to the second embodiment.

FIG. 13 is a perspective view showing a third clip which can be used to join sections of edging made according to of the second embodiment.

FIG. 14 is a perspective view showing a fourth clip which can be used to join sections of edging made according to of the second embodiment.

FIG. 15 discloses details of additional applications.

FIG. 16 discloses a third embodiment of the edging.

FIG. 17 shows details of the third embodiment of FIG. 16.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words upwardly, Adownwardly, rightwardly, and leftwardly will refer to directions in the drawings to which reference is made. The words inwardly and outwardly will refer to directions toward and away from, respectively, the geometric center of the embodiment being described and designated parts thereof. Said terminology will include the words specifically mentioned, derivatives thereof and words of a similar import.

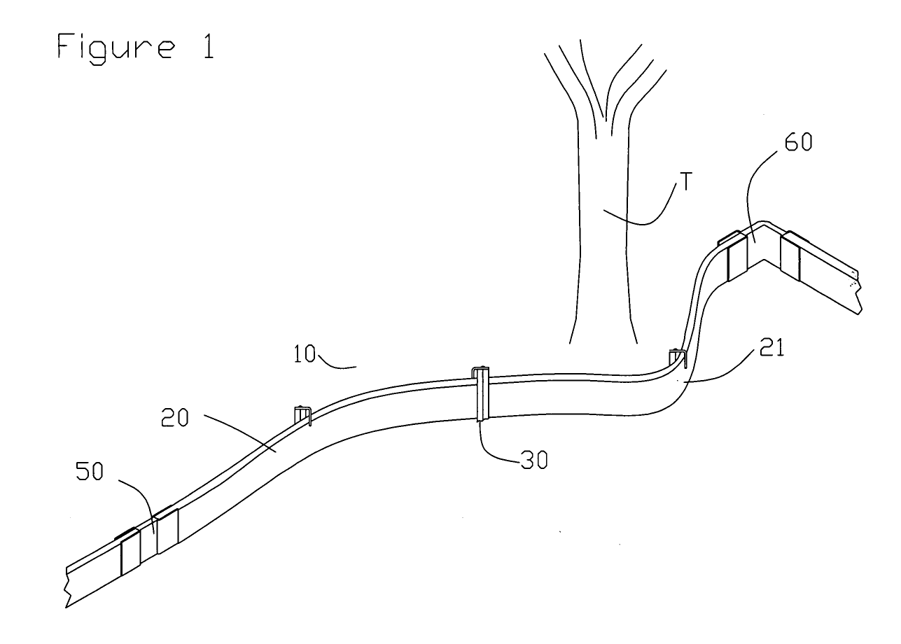

FIG. 1 shows an edging system 10 installed in a typical application. The edging system 10 includes a length of flexible fiberglass edging 20. A lower portion of the edging 20 is not shown in this view as it is underground in the typical application. The edging 20 is flexible and is shown bending at a curve 21 to go around an obstacle such as a tree T. The system 10 includes stakes 30, straight connectors 50, and corner connectors 60. Although the stakes 30 can be of any conventional type, a special fiberglass stake 30 designed to match the edging 20 is shown. The edging 20 and stakes 30 of the system 10 can be made in a variety of different colors and decorative patterns.

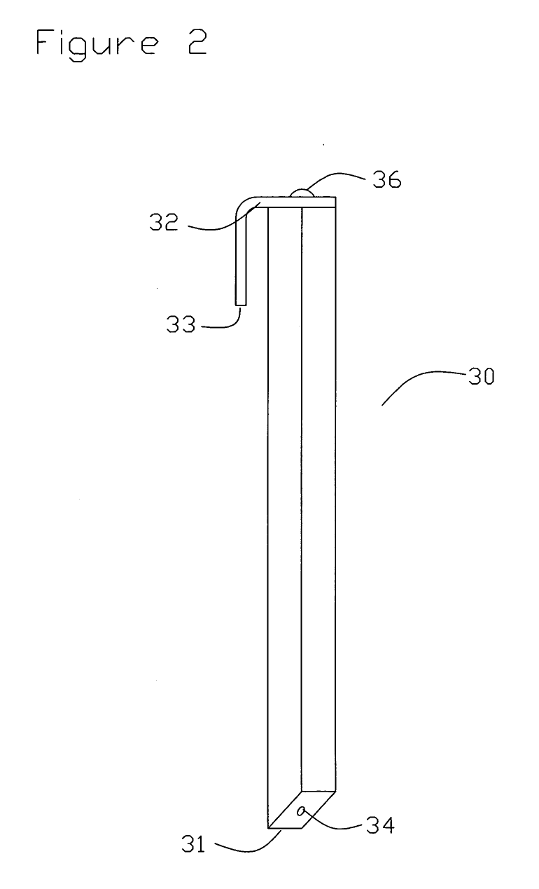

FIG. 2 shows a pultruded fiberglass stake 30. The stake 30 has a sharpened end 31 and a hole 34 that passes lengthwise through the stake 30. A clip 32 with an extended arm 33 is held to the stake 30 by a screw or rivet 36 which uses the hole 34 as a pilot hole. For example, the stake 30 can be driven into position next to the edging 20 with the clip 32 positioned over the edging (as shown in FIG. 1) and a screw 36 can be driven into the stake 30 to hold the clip in place. This fiberglass stake 30 would have many of the same advantages stated above for fiberglass and would match the edging material 20, however any conventional stake material would also work.

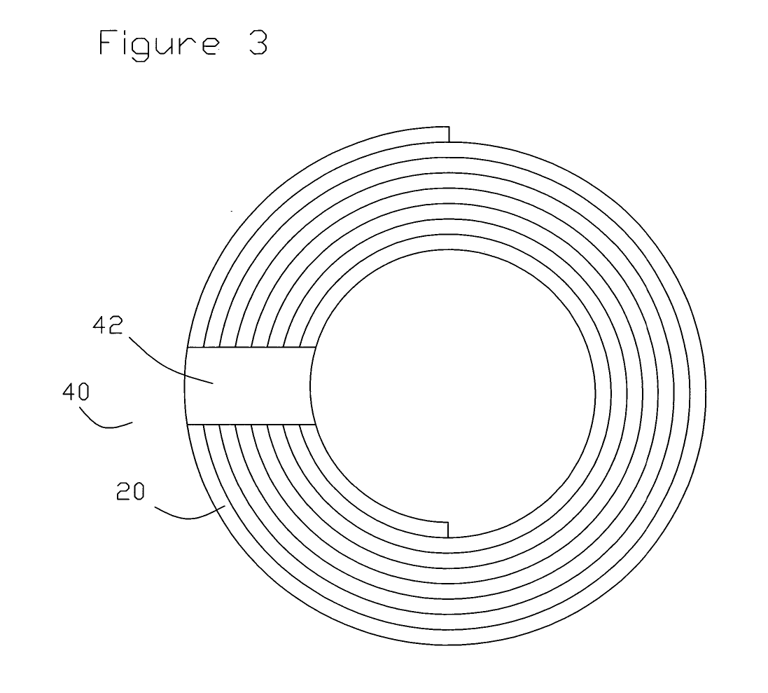

FIG. 3 shows a roll 40 of the edging 20 ready for shipping to a installation location. Forming the edging 20 into rolls 40 makes it easy to handle and ship. The roll 40 is held together with a piece of strapping tape 42. The roll 40 can be boxed or displayed in a store without a box. Typically the roll 40 might comprise a strip or the edging 20 which is twenty-five to one hundred feet in length.

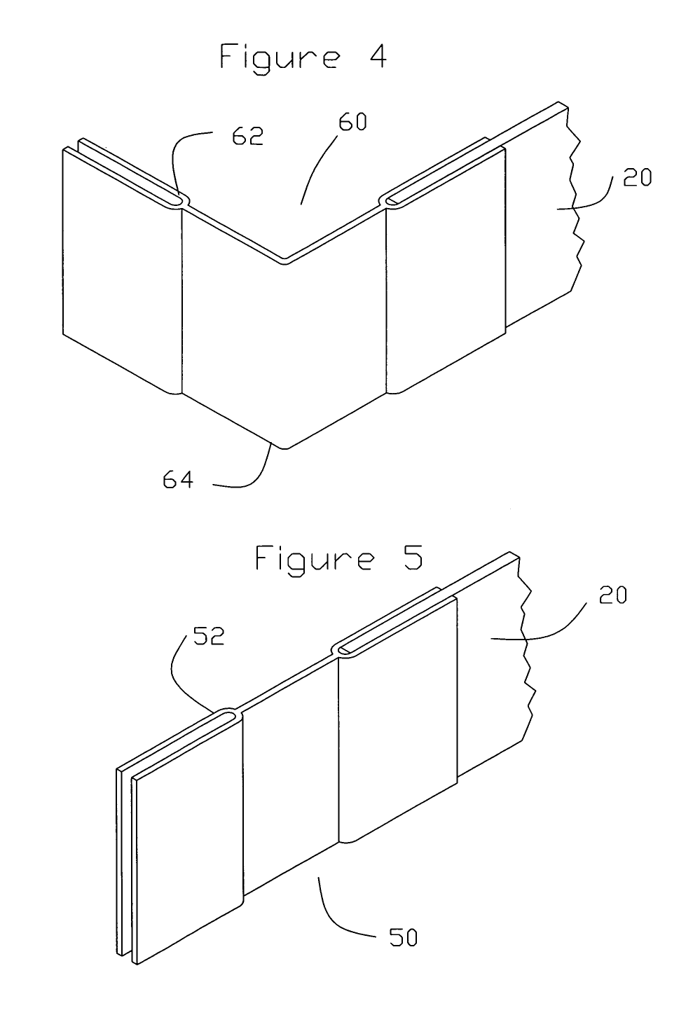

FIG. 4 shows how one of the corner connectors 60 works. The connector 60 includes two slots 62, each of which is adapted to accepting an end of a respective strip of the edging 20. The connector 60 includes a bend 64 between the slots 62, which is shown as a ninety degree bend. By placing an end of a respective strip of the edging 20 in each slot 62 a sharp ninety degree bend between the strips can be created. Other bends such as forty-five degree bends would also be possible. The connector 60 allows the system 10 to include a sharp corner, whereas the pultruded fiberglass edging 20 typically can not bend at a sharp angle. The corner connector 60 can be made of pultruded fiberglass which matches the edging 20 or from an accent material.

FIG. 5 shows one of the straight connectors 50. The connector 50 includes two slots 52, each of which is for accepting an end of a respective strip of the edging 20. This connector allows for splicing two pieces of edging 20 together to make a long run of edging 20.

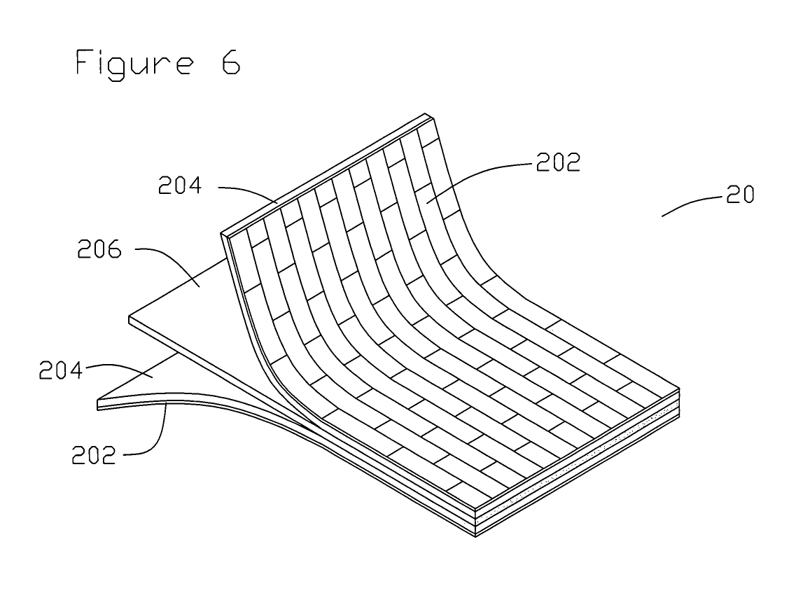

FIG. 6 shows an exploded view of the layers of the edging 20. The edging 20 includes exterior veil layers 202 on both sides. The veil layers 202 are formed of a polyester material that can be printed with patterns to give the edging 20 the appearance of any desirable material such as brick (as shown), stone or wood. Positioned inwardly from the veil layers 202 are continuous strand mat layers 204 which consist of a thin mats of randomly oriented fiberglass strands. A center or “rovings” layer 206 is sandwiched between the continuous strand mat layers 204. The rovings layer 206 consists of a mat of long fibers oriented parallel to the length of the edging material 20.

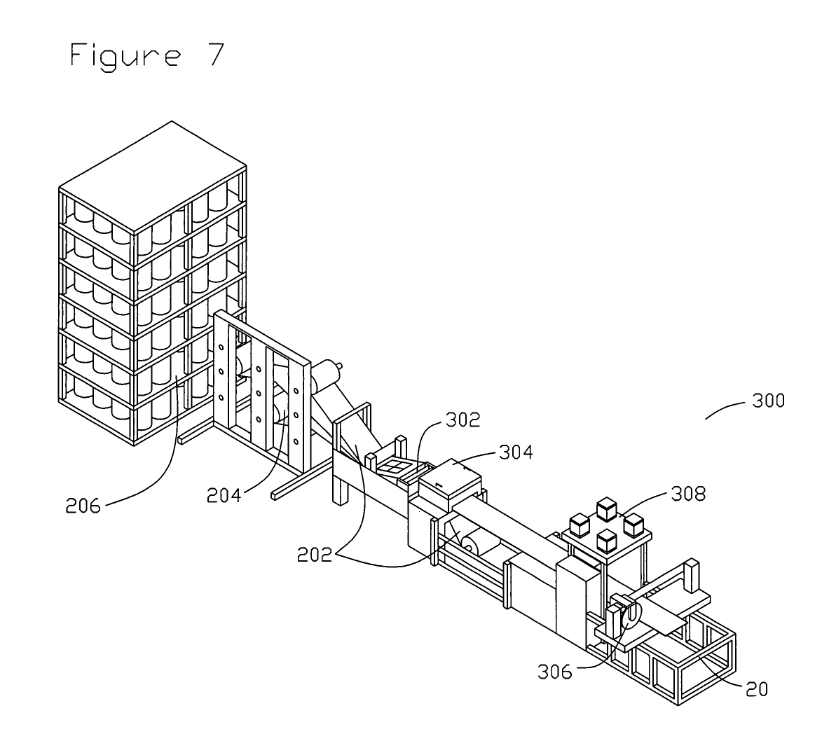

Referring to FIG. 7, in the manufacturing process 300, the unidirectional rovings layer 206 is sandwiched between the two continuous strand mats 204 and this assembly is pulled through a vat of thermoset resin 302. The veil 202 is then applied to both sides and the assembly is pulled through a heated die 304. The lengths of edging 20 are cut by a cut off saw 306 as the material comes out of the puller 308.

In use, a trench one to two inches deep is dug where the system 10 is to be installed. One end of a roll 40 of the edging 20 is placed at the desired beginning of the edging trench (not shown) and secured by driving a stake 30 down beside the edging 20 as shown in FIG. 1. The edging 20 is then unrolled and staked at intervals of a few feet. For long runs involving multiple rolls 40, the straight connectors 50 can be used to provide an attractive splice, or if desired the ends of two rolls 40 can simply overlap to create an attractive, continuous boarder. At locations where a tight ninety degree bend is required, such as where two sidewalks come together, a corner connector 60 can be used. The edging 20 can be cut to length using tools used to cut conventional metal edging such as tin snips or a hack saw.

### SECOND EMBODIMENT

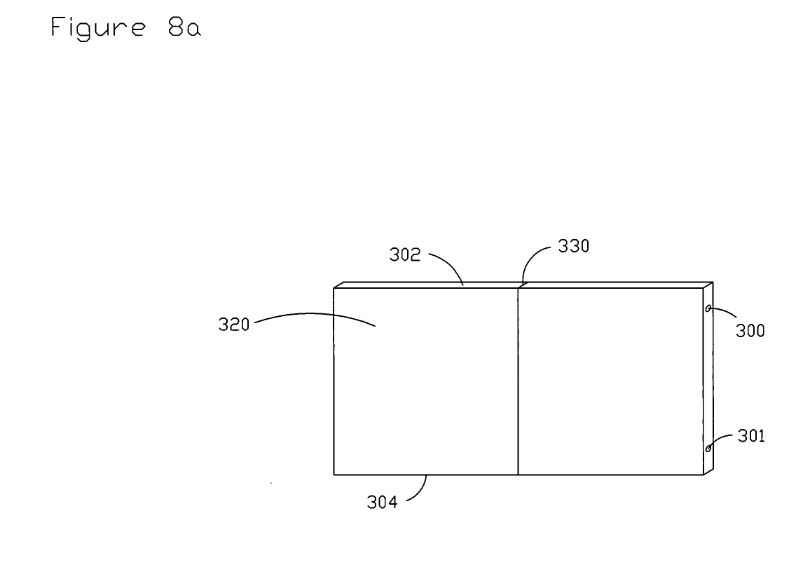

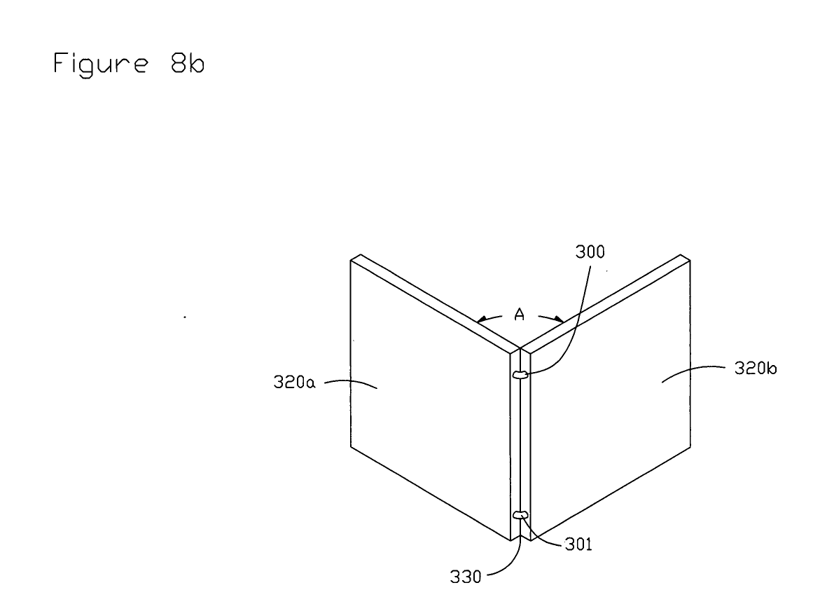

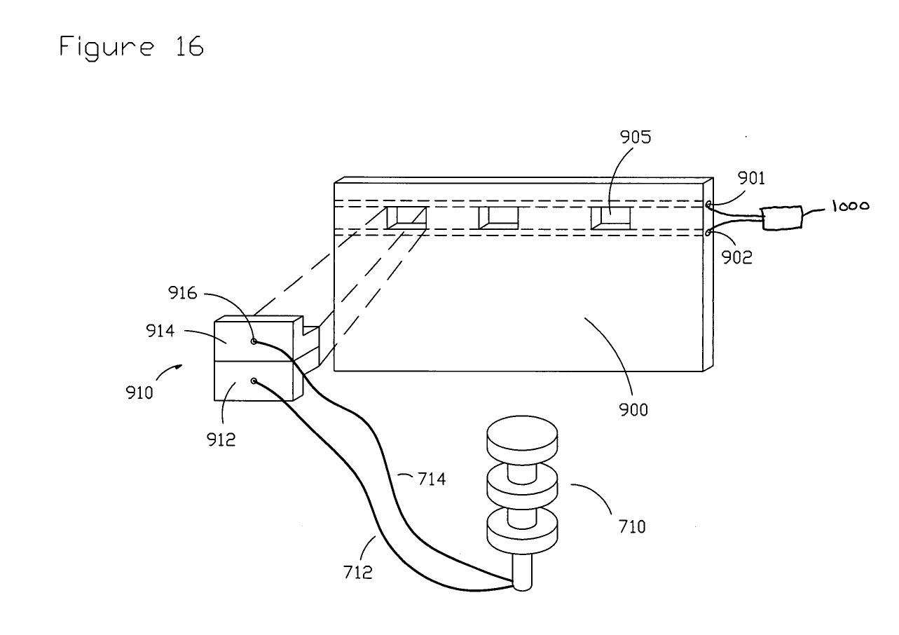

FIGS. 8a-13 show details of a second embodiment 320 of the lawn edging of the present invention. The edging 320 includes one or more electrical wires or conductors 300,301 which are embedded in the edging 320 and are usable to supply electric current from a power source (1000 in FIG. 16) to low voltage outdoor lighting or for other applications or curcuits. For example, FIG. 8a shows a pultruded fiberglass edging 320 having a pair of electrical conductors or wires 300,301 formed therein. One conductor 300 is located near a top edge 302 of the edging 320 and a second conductor 301 is located near a bottom edge 304 of the edging 320. The conductors 300,301 can run the full length of the edging 320. The electrical conductors 300,301 may be formed of metal wire, such as copper wire. Alternatively, both conductors or wires 300,301 may be embedded in the edging 320 in closely spaced and parallel relation near the top edge 302, near the bottom edge 304, or anywhere in between.

The conductors 300,301 can each replace one of the continuous strands in the rovings layer 206 that would otherwise be pultruded into the edging 20, so that uniform thickness of the edging may be maintained. For example, the edging 20 described above without inclusion of the copper wire 300 may include 24 strands of glass. If two copper wires 300 are utilized, two strands of glass would be removed, leaving 22 strands of glass and 2 copper wires in the edging 320. Producing edging 320 of uniform cross-section which is relatively thin and flexible and facilitates packaging, storing and display of the edging 320.

Fiberglass edging 320 is generally very tough but can be subject to crushing from a blow applied to an edge such as the top edge 302 during installation. If positioned near the top edge 302 and the bottom edge 304 of the edging 320, the wires 300,301 can also act as structural supports to strengthen the edges and lessen damage which might be caused when the edging 320 is driven into the ground. It has been found that a copper wire 300 on the order of 1/32 to 1/4 inch in diameter is capable of strengthening the top edge 302 of the edging 320 to lessen damage to the edging 320 caused when a user drives the lawn edging 320 into the ground and yet is sufficiently small and flexible to be capable of being pultruded into the edging 320 as the edging is formed by the fiberglass pultusion process discussed above.

The fiberglass edging 320 can be in a thickness range of 1/16 inch to ⅜ inch and is more preferably in a range of 1/8 inch to 3/16^{th} inch thick. The wire can be in a range from 3 the thickness of the edging up to just under the overall thickness of the edging. A more preferred range would be a wire diameter ⅛ to ½ the thickness of the edging 320 to give ideal strength, flexibility and manufacturability of the wire and of the resulting edging 320.

FIG. 8b shows that if the edging 320 can be scored with a knife or saw along line 330 the edging 320 can be folded into two pieces 320a and 320b. The two pieces 320a and 320b can be hinged to any angle A desired by the user and still maintain a wire connection between the two pieces 320a and 320b. The result is a living hinge formed by wires 300,301.

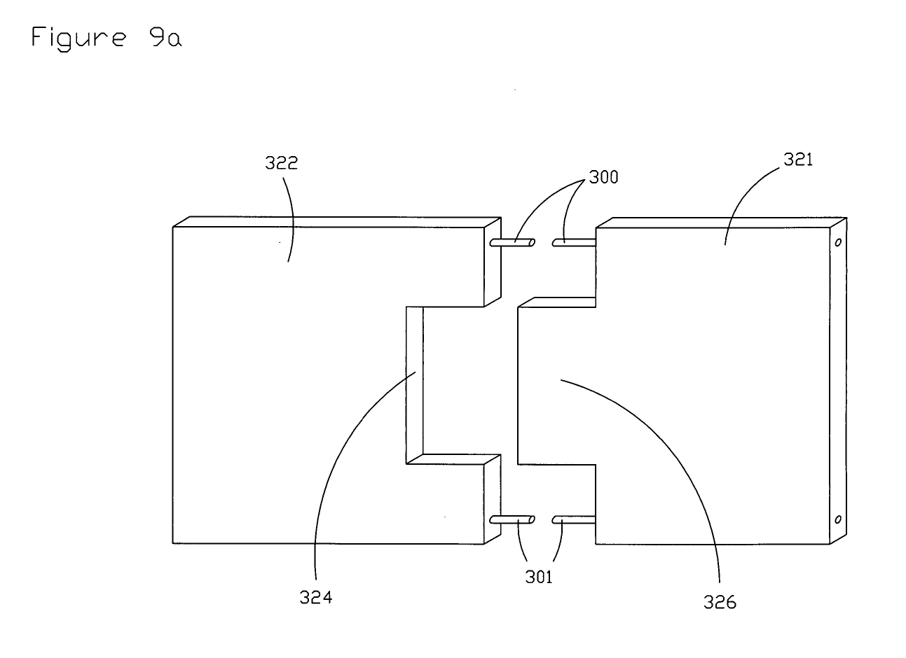

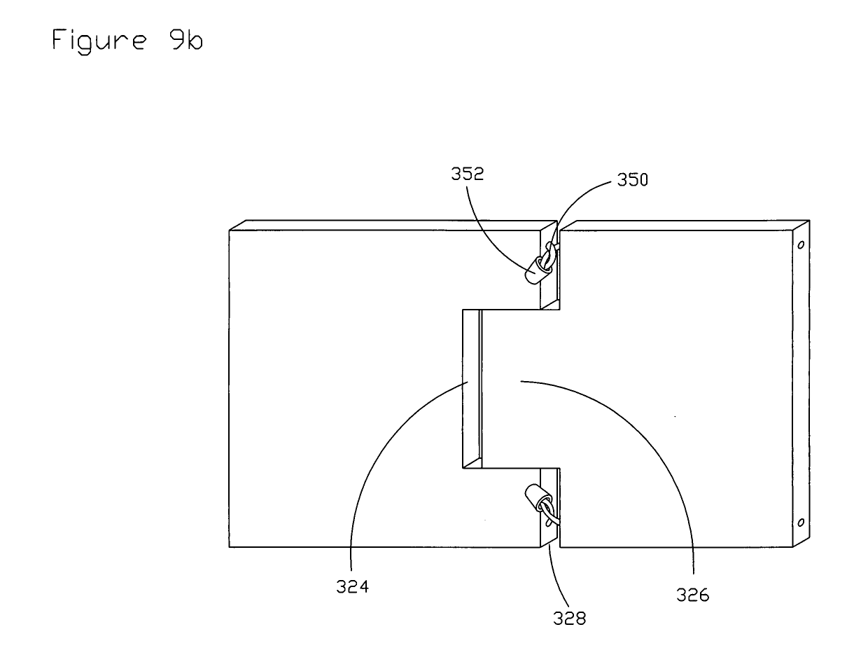

FIGS. 9a and 9b show that the wires 300, 301 can be used to connect two edging pieces 321 and 322 together. FIG. 9a shows two pieces 321 and 322 that are to be joined together. Fiberglass material can be cut away to expose ends of wires 300, 301 and cooperating male tab 326 and female notch 324 can be formed into the ends of edging pieces 321 and 322.

FIG. 9b shows that the tab 326 and notch 324 can be joined to form a connection that can be secured be tying wires 300, 301 together to form a wire tie 350. The wire tie 350 can be formed with or without using a wire nut 352. The two pieces 321 and 322 can represent two full length pieces that are to be spliced together or the two pieces 321, 322 can represent a repair or a splice needed for any reason.

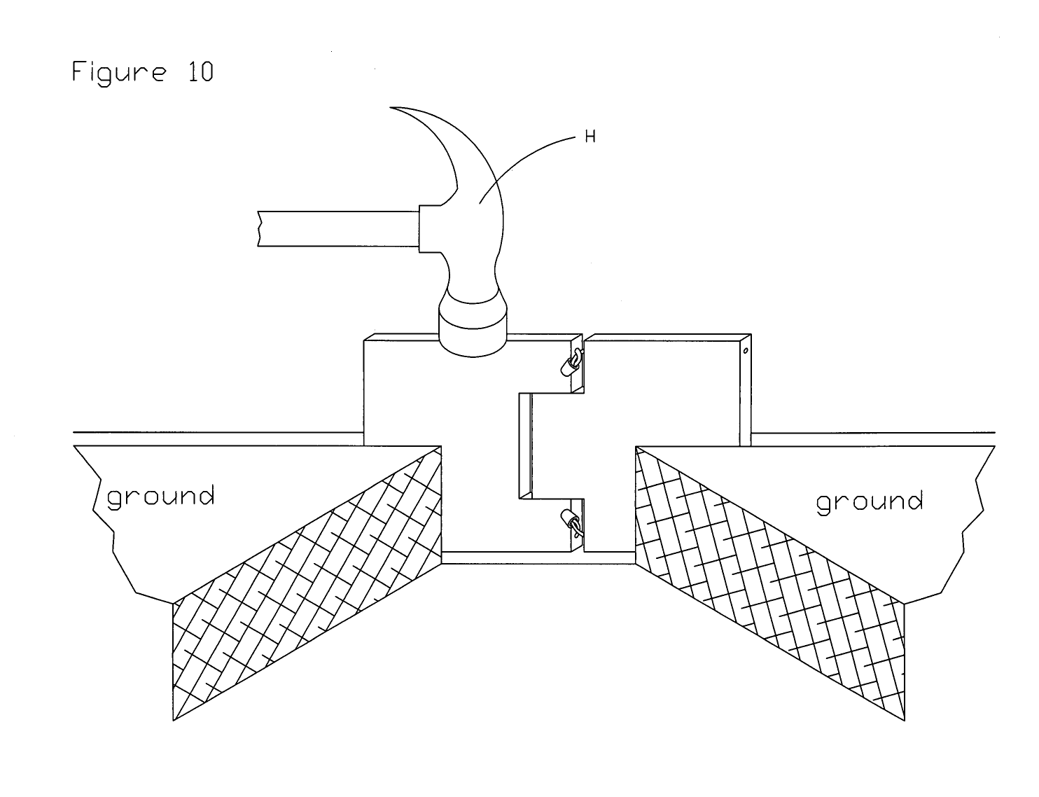

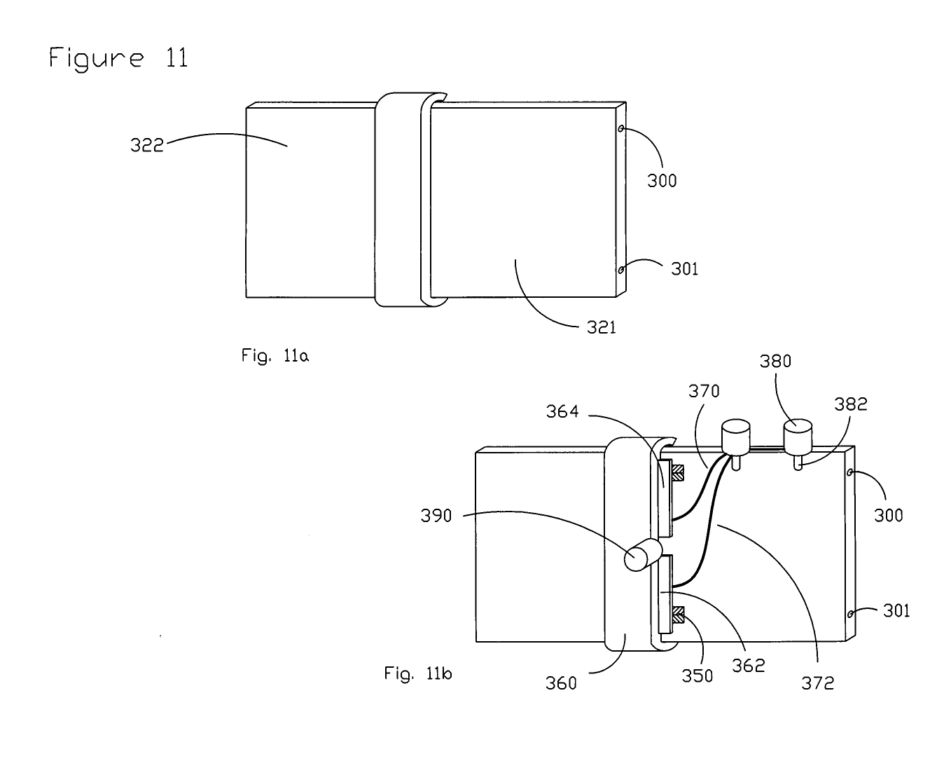

FIG. 10 illustrates how the spliced pieces 321 and 322 form a complete edging that can be driven into a groove G in the ground using hammer H.

FIGS. 11a and 11b show further details of the second edging embodiment. A clip 360 can hold together the two edging pieces 321 and 322 and cover the joint 328 between them. The clip 360 can slide onto either piece 321, 322 and can slide over the wire tie 350 where wire nut 352 is not used. The clip 360 can include contacts 362 and 364 that can be used to conduct low voltage electricity to or from the wires 300, 301. As shown, contacts 362 and 364 can conduct low voltage electricity to a light or LED 390 on the clip 360 or the contact 362 can supply one polarity of low voltage DC electricity to wire 372 and contact 364 can conduct an opposite polarity to power lights 380 clipped 382 to the edging pieces 321,322. This arrangement could be used for solar lawn lights, Christmas lights or for low voltage Malibu lights for example. The arrangement can be used to conduct low voltage electricity for any purpose. The clip 360 can serve to connect the two pieces 321, 322 to protect the wire tie 350 and to connect wire ties 350 to conduct electricity for lighting or other purposes. The arrangement provides for lawn edging and for an electrically conductive flexible fiberglass strip where the fiberglass and the outer veil electrically insulate the wires 300,301 inside the edging pieces 321, 322.

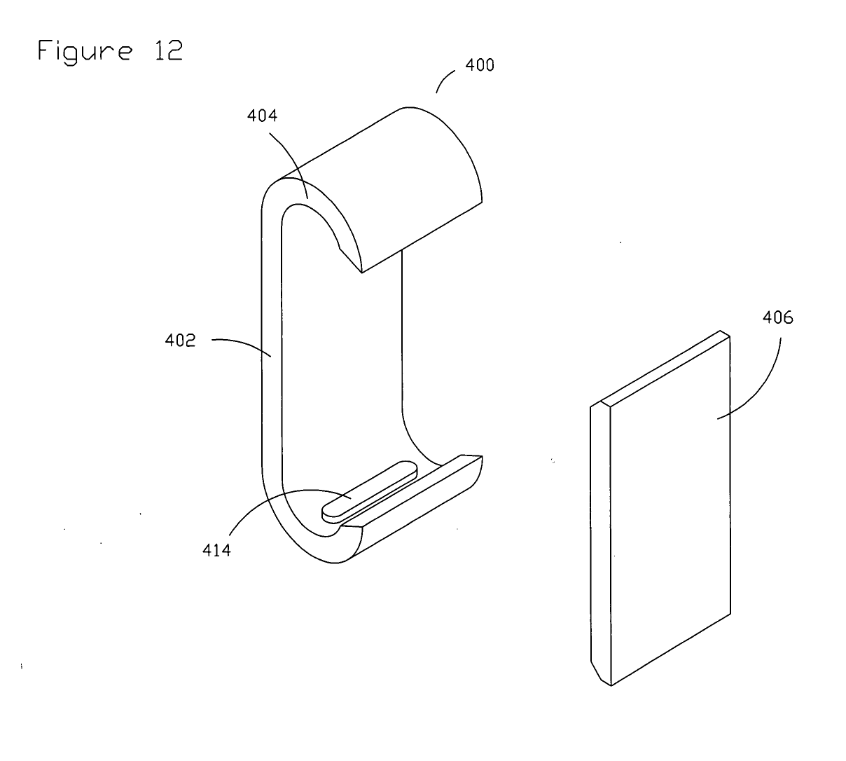

FIG. 12 shows an alternate clip 400. The alternate clip 400 is a two piece design with a slider 402 that can fit over the edging pieces 321, 322 and a wedge 406. The slider 402 can include grips 404 that allow the slider 402 to fit over edging pieces 321, 322 while still allowing it to slide along the edging. The wedge 406 has a height taller than the opening between the two grips 404 such that it can wedge against the edging piece 321, 322 to hold the pieces 321, 322 and clip 400 together. The clip 400 can include metal contactors 414 such as foil. The clip 400 can be extruded from fiberglass or could be plastic or metal.

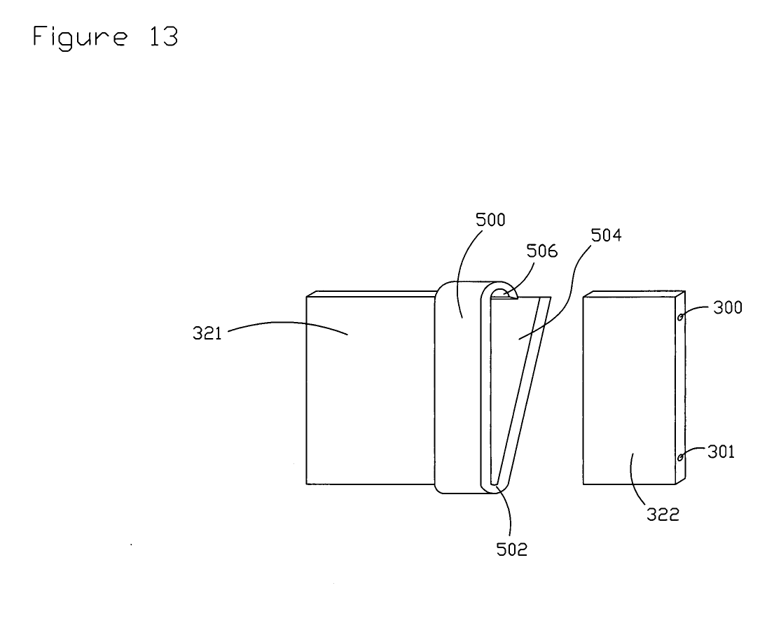

FIG. 13 shows a third clip 500. The clip 500 can be formed from plastic and can include a living hinge 502. The clip 500 can include a long leg 504 that can cooperate with a hook portion 506 to lock the clip 500 around the edging 321 to couple one edging piece 321 to edging piece 322. This clip 500 could also function to connect edging 20.

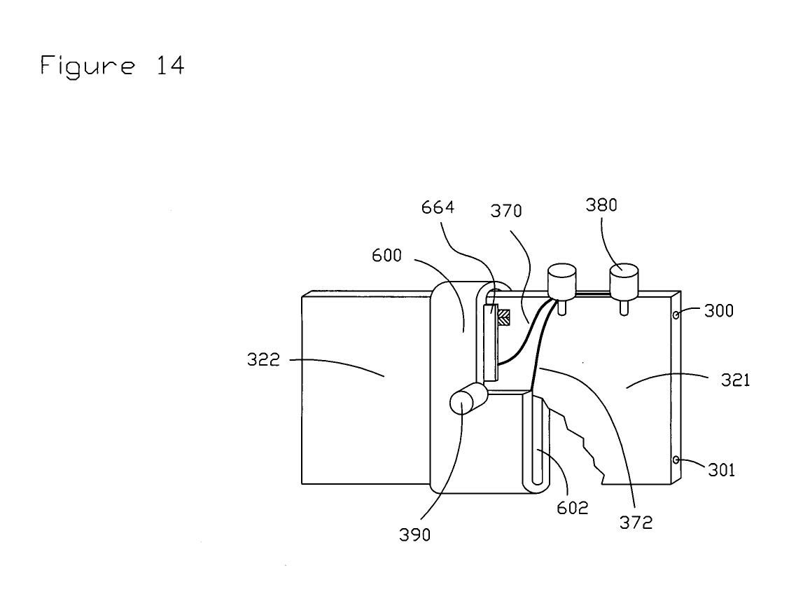

FIG. 14 discloses a fourth clip 600. The clip 600 forms an entire loop that can slide over the edging pieces 321, 322. The clip 600 can also carry electrical contactors 664 and wires 370, 372 to electrically connect the wire tie 350 to the lights 380 and/or 390. The clip 600 can have an opening 602 that can fit tightly over the profile of the edging pieces 321, 322 such that they will be frictionally held together and such that the electrical contacts 664 will be covered and held tight against the wire tie 350. Electrically connected lights 380 can be spaced out along the length of the lawn edging pieces 321, 322.

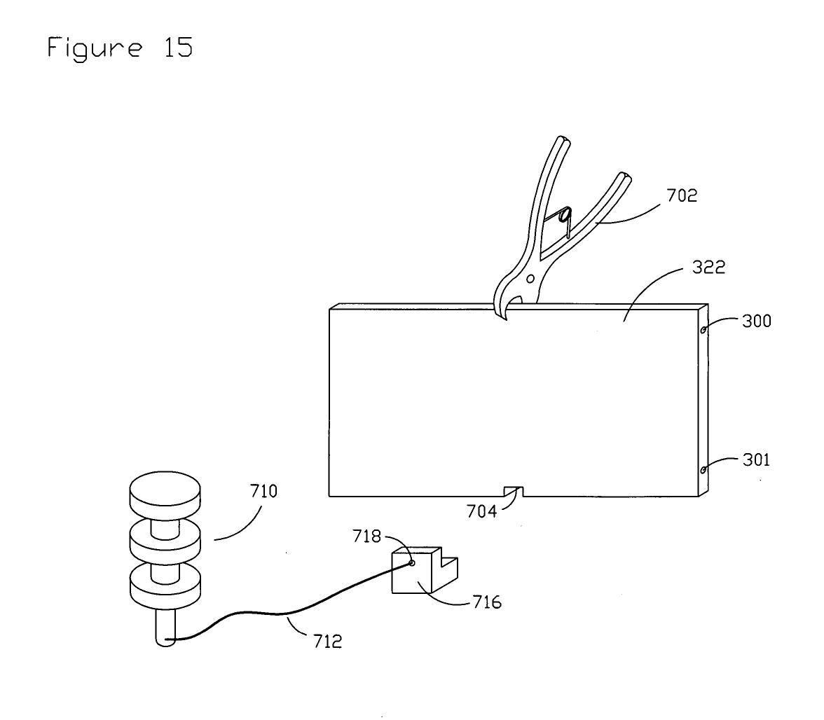

FIG. 15 shows edging piece 322 having wires 300, 301 running along its length. In order to connect to the wires 300, 301 a notch 704 can be cut using cutters 702. The notch would expose a portion of wires 300 or 301. This could allow for electrical connection to the wires 300,301. A wire 712 to power a Malibu light 710 can end in a clip 716 that has an electrode 718. The clip 716 can press fit into the notch 716 with the electrode 718 making electrical connection to the wire 301 to allow low voltage electricity carried by the lawn edging piece 322 to flow to the Malibu light 710 which can be staked in the ground adjacent the lawn edging.

### THIRD EMBODIMENT

FIG. 16 discloses an alternate embodiment of the lawn edging 900. This thin fiberglass edging can include a plurality of holes 905 punched through the edging 900. These holes 905 could be formed in the edging 900 as part of the manufacturing process. The edging 900 also includes two wires 901, 902 which can be electrical conductors as well as serving to strengthen the upper portion of the edging 900. At installation, the wires 901, and 902 can carry low voltage DC current to power lawn mounted electrical devices such as Malibu light 710. A clip 910 can be press fit into the hole 905. The clip can consist of an upper portion 914 and a lower portion 912 each having an opening 916 through which passes a wire 712, 714. With the clip 910 pressed into the hole 905 electricity can pass from a power source 1000 through the wires 901, 902 to the wires 712, 714 and on to light 710 making a complete electrical circuit.

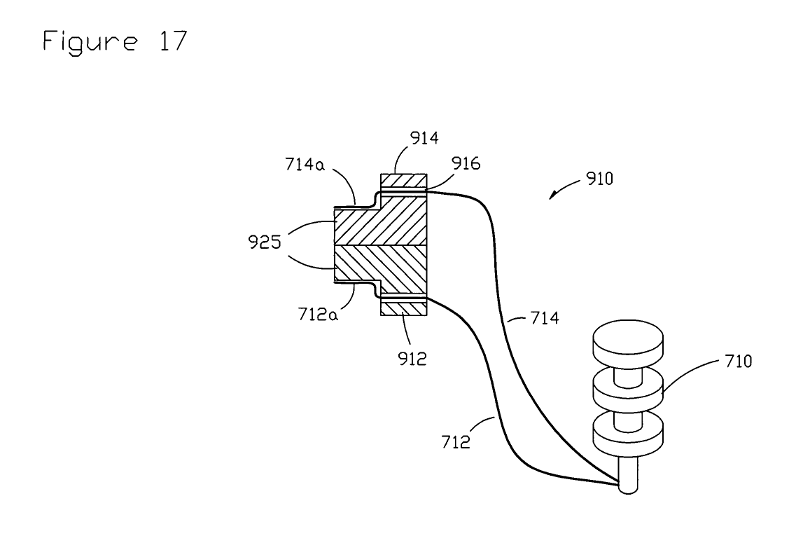

FIG. 17 shows a section view of the clip 910. The wires 712 and 714 each end in an electrical contactor 712a and 714a. The clip 910 can include a plug portion 925 sized to press fit into hole 905. The plug portion 925 can include a one way device such as prong 930 that will engage the hole 905 to restrict removal of clip 910 once plug portion 925 is inserted into hole 905. The clip 910 can be molded from any non-conducting material such as plastic, fiberglass, rubber or polyester. A flexible plastic may provide the best fit.

It is to be understood that while certain forms of the present invention have been illustrated and described herein, it is not to be limited to the specific forms or arranged of parts described and shown. For example, it is foreseen that the conductors or wires 300 could be sandwiched between a veil layer 202 and the adjacent continuous strand mat layer 204 or the wires 300 can be between one of the continuous strand mat layers 204 and the rovings layer 206. In such an embodiment the thickness of the edging 20 around the wires 300 could be greater than the thickness of the edging 20 elsewhere.

1. A lawn edging system for installation in ground contact comprising a first section of fiberglass lawn edging having a top edge, a bottom edge, a pair of opposed ends, a length, and a thickness; said first section of fiberglass lawn edging including an electrical conductor formed therein and running continuously along said length, said conductor having a diameter in the range of ¼ to ½ of said thickness of said first section of fiberglass lawn edging.

2. The lawn edging system as in claim 1 wherein said first section of fiberglass lawn edging includes a rovings layer comprising a plurality of unidirectional glass strands and said conductor is located in said rovings layer and oriented parallel to said glass strands.

3. The lawn edging system as in claim 1 wherein said conductor is located adjacent said top edge of said first section of fiberglass lawn edging.

4. The lawn edging system as in claim 1 wherein said conductor is a copper wire.

5. The lawn edging system as in claim 1 wherein said conductor is a first conductor and said first section of fiberglass lawn edging further including a second conductor.

6. The lawn edging system as in claim 5 wherein said second conductor is located adjacent said bottom edge of said first section of fiberglass lawn edging.

7. The lawn edging system as in claim 6 wherein said first and second conductors are copper wire.

8. The lawn edging system as in claim 1 and further including a low voltage light powered by electricity conducted through said wire.

9. A lawn edging system for installation in ground contact comprising a first section of fiberglass lawn edging having a top edge, a bottom edge, a pair of opposed ends, a length, and a thickness, said first section of fiberglass lawn edging including a wire formed therein adjacent said top edge and running continuously along said length, said wire having a diameter in the range of ¼ to ½ said thickness of said first section of fiberglass lawn edging.

10. The lawn edging system as in claim 9 wherein said first section of fiberglass lawn edging includes a rovings layer comprising a plurality of unidirectional glass strands and said wire is located in said rovings layer and oriented parallel to said glass strands.

11. The lawn edging system as in claim 9 wherein said wire is a first wire and said first section of fiberglass lawn edging further including a second wire located adjacent said bottom edge of said first section of fiberglass lawn edging.

12. The lawn edging system as in claim 9 and further comprising a second section of fiberglass edging, said second section including a second wire adjacent a top edge of said second section of edging, wherein said first and second wires are interconnectable to flexibly secure said first section to said second section.

13. The lawn edging system as in claim 12 wherein said first section of edging includes a notch formed at one of said ends and wherein said second section of lawn edging includes a tab formed at an end thereof and wherein said notch and tab cooperate to form a joint between said first and second sections.

14. The lawn edging system as in claim 9 wherein said wire is electrically conductive.

15. The lawn edging system as in claim 14 wherein said first section of lawn edging includes at least one veil layer that forms an exterior surface of said edging and electrically insulates said wire.

16. The lawn edging system as in claim 15 wherein said first section of fiberglass edging can be bent in a sharp angle by scoring said veil layer and breaking said first section of fiberglass edging without damaging said first wire.

17. The lawn edging system as in claim 14 and further including a low voltage light powered by electricity conducted through said wire.

18. A lawn edging system for installation in ground contact comprising a first section of fiberglass lawn edging having a top edge, a bottom edge, a first end, a second end, a length, and a thickness, said first section of fiberglass lawn edging including a first conductor enclosed in said first section adjacent said first edge and a second conductor enclosed in said first section.

19. The lawn edging system as in claim 18 wherein said first and second conductors are copper wires.

20. The lawn edging system as in claim 19 and further comprising a second section of fiberglass edging, said second section including a third wire enclosed therein adjacent a top edge of said second section and a fourth wire enclosed therein adjacent a bottom edge of said second section, one of said ends of said first section and an end of said second section forming a joint there between, wherein said first and third wires can be interconnected to flexibly secure the joint.

21. The lawn edging system as in claim 20 wherein said second and fourth wires can be interconnected to further flexibly secure the joint.

22. The lawn edging system as in claim 20 and further including a low voltage light powered by electricity conducted through said first and second wires.

23. The lawn edging system as in claim 20 and further including includes a clip to cover said joint.

24. The lawn edging system as in claim 23 wherein said clip includes first and second terminals in electrical contact with said first and second wires, respectively.

25. The lawn edging system as in claim 24 and further including a low voltage light connected to said first and second terminals and powered by electricity conducted through said first and second wires.

26. The lawn edging system of claim 18 including a hole in said edging in a space between said first and second conductors and a clip fitted in said space, said clip including a first electrical contact contacting said first conductor.

27. The lawn edging system of claim 26 wherein said clip includes a second electrical contact, said second electrical contact in contact with said second conductor.

28. The lawn edging system of claim 26 wherein said first and second electrical contacts are electrically connected to a light.
